(19) United States
(12) Patent Application Publication
(10) Pub. No.: US 2021/0359432 A1
(43) Pub. Date: Nov. 18, 2021

(54) System and Method for Establishing a Graphite Ground System

(71) Applicant: Armando Limongi, KISSIMMEE, FL (US)

(72) Inventor: Armando Limongi, KISSIMMEE, FL (US)

(21) Appl. No.: 17/322,761

(22) Filed: May 17, 2021

Related U.S. Application Data
(60) Provisional application No. 63/025,627, filed on May 15, 2020.

(51) Int. Cl. H01R 4/66; H01B 1/04

(52) U.S. Cl. CPC H01R 4/66; H01B 1/04

(57) ABSTRACT

A system and method for preparing and installing a graphite ground system is able to establish a durable conductive ground suitable for use in dissipating electrical current in conjunction with larger sensitive electronic installations. The method is provided with an excavation tool, an installation site, a volume of substrate, a volume of catalyst, a volume of conductive additive, a ground lead, and at least one regulated current source. The excavation tool is used to prepare the installation site for an in-situ preparation of the volume of substrate, the volume of catalyst, and the volume of conductive additive. The resultant conductive slurry is further modified with the integration of the ground lead, whereby the regulated current source may be electrically connected to earth (electrical ground). The conductive slurry is subsequently compacted and solidified into a conductive ground element, capturing the ground lead and ensuring a consistent electrical connection to ground.

The current application claims a priority to the U.S. Provisional Patent application Ser. No. 63/025,627 filed on May 15, 2020. The current application is filed on May 17, 2021 while May 15, 2021 was on a weekend.

### FIELD OF THE INVENTION

The present invention relates generally to the field of electrical infrastructure and conductive materials sciences. More specifically, the present invention presents a means and method for establishing a durable, cost-effective conductive ground contact for sensitive electronic systems.

### BACKGROUND OF THE INVENTION

Common electrodes in grounding systems include copper-well bars, copper conductors, active electrodes (chemical bars), plates, tubes, metal armors, etc. Ground systems are made according to calculations of the ground's resistivity, e.g., the resistance present in a soil's cube of one meter (Ω/m) of edge by the passage of electric current (p), and the grounding resistance value which is the resistance that will oppose the passage of the electric current to the ground when using an electrode introduced into the ground. The effectiveness of a grounding system will be given by the value of the grounding resistance, which is the combination of the ground resistivity, the type of electrode, and the contact of the electrode with the ground.

Current grounding systems reach a grounding resistance that, according to the normative, fluctuate between 20, 10, and 5Ω/m of resistance. With the recent implementation of microprocessors, the conventional grounding systems have difficulties because the resistance needed must be lower than the normalized ones. Resistance values should be lower than 5Ω and in some cases between 3 to 1Ω. To reach these values, electrodes and conductors often require expansive installations involving large areas or deep excavations into the soil. Further, as the adoption of high-density electronic installations increases, grounding system electrodes capable of offering resistance lower than 1Ω will become necessary. However, current technology presents four basic problems:

1. Electrochemical influence on the ground rod (corrosion); all metals used for grounding systems inserted into the soil corrode due to chemical reactions between the area humidity and the electrode, chemical agents contained in the terrain, electric currents running across the terrain, electrochemical corrosion, oxygen corrosion, microbiological corrosion, galvanic corrosion, neutral salt corrosion, and corrosion due to the material's heterogeneity. The corrosion produces variable instability over time according to the soil composition, representing an increase in grounding resistance and the weakening of the electrode's material. Further, the electrode could fuse after a certain time due to atmospheric discharge or a lack of electric supply, which leaves a connected facility unprotected. Generally, current electrode materials are non-reliable with a limited lifespan in any kind of terrain.

2. Grounding electrodes or mesh sizes; in most cases, the design of the grounding electrode takes into consideration the size of the conductor that will be buried (horizontal conductor or electrode) and the different metal electrode interconnections that will form the multiple electrode ground system (vertical electrodes) which are based on the ground's resistivity and the resistance needed. Depending on the land resistivity, large and costly grounding electrodes requiring large amounts of material (conductors, ground electrodes, connections) and labor (excavations, pushing of grounding pegs, etc.) are necessary. In many cases, the installations do not have an area big enough for large grounding mesh, requiring empirical solutions and, in the worst of the cases, being unable to provide solutions using the existing technology. Large installations also are susceptible to high corrosion, which in turn results in high construction/maintenance costs and limited lifespans.

3. Maintenance; the maintenance of conventional grounding electrodes must be measured over time to test the performance of the grounding system. The maintenance process is a complex and expensive process that requires the soil to be recompressed before the electrodes can readapt to the environment. This results in an inactive period during which any connected facilities are vulnerable to ground-faults.

4. Theft; one of the biggest problems of ground systems worldwide is theft due to the use of copper in the ground systems. Copper is one of the most-stolen non-ferrous metals. When copper components are stolen, the facilities are left unprotected and out of service.

To overcome the prior art's current shortcomings, an objective of the present invention is to provide a graphite ground system. The graphite ground system emerges as the next stage of grounding system's engineering art. The present invention comes to proposes novel means and methods to break paradigms of electrical engineering, providing both technical and practical improvements upon prior art. The present invention proposes a means of establishing a grounding system capable of reaching resistances under 1Ω, resisting any corrosion or environmental damage. Further, the present invention may be constructed in areas smaller than 10 square feet, requires little to no maintenance, is not attractive to theft, and is 100% environmentally friendly.

Additional advantages of the invention will be set forth in part in the description which follows, and in part will be obvious from the description, or may be learned by practice of the invention. Additional advantages of the invention may be realized and attained by means of the instrumentalities and combinations particularly pointed out in the detailed description of the invention section. Further benefits and advantages of the embodiments of the invention will become apparent from consideration of the following detailed description given with reference to the accompanying drawings, which specify and show preferred embodiments of the present invention.

### BRIEF DESCRIPTION OF THE DRAWINGS

FIG. 1 is a flowchart illustrating the overall process of the present invention.

FIG. 2 is a flowchart illustrating a sub-process for reburying a partially cured conductive ground element, wherein a solidification and compaction process creates an effective path to earth.

FIG. 3 is a flowchart illustrating a sub-process for preparing an area to be permeable to poured substances, thereby improving overall conductive contact of an installed grounding element.

FIG. 4. is a generalized schematic view of the method of the present invention, wherein an excavation and admixture process are illustrated.

FIG. 5 is a generalized schematic view of the method of the present invention, wherein a slurry agitation and initial soil compaction process are illustrated. Additionally, the initial placement of an electronic ground contact is shown in exemplary form.

FIG. 6 is a generalized schematic view of the method of the present invention, wherein a reburial process is shown prior to an exemplary view of a fully solidified installation of the present invention.

FIG. 7 is an alternate perspective view of the solidified installation of the present invention, wherein the topsoil and ground coverings are shown as transparent to illustrate construction and material qualities.

### DETAILED DESCRIPTION OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced or utilized without the implementation of some features as they are described. It should be understood that some details have not been described in detail in order to not unnecessarily obscure focus of the invention. References herein to “the preferred embodiment”, “one embodiment”, “some embodiments”, or “alternative embodiments” should be considered to be illustrating aspects of the present invention that may potentially vary in some instances, and should not be considered to be limiting to the scope of the present invention as a whole.

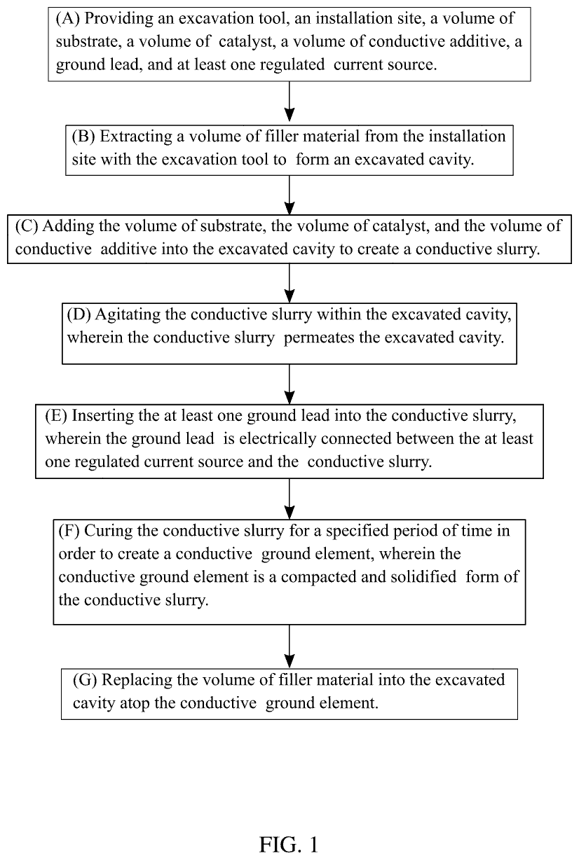

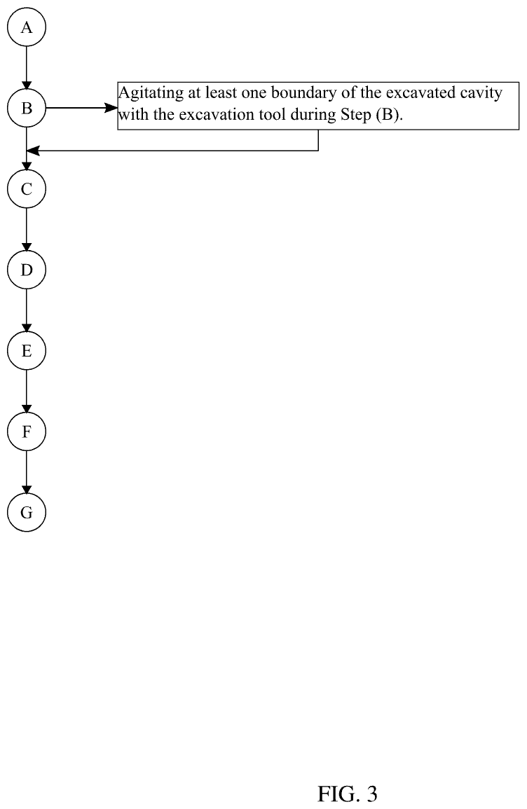

In reference to FIG. 1 through 7, the present invention is a system and method for establishing a graphite ground system. The novel composition and construction techniques related herein are proposed to create an effective electrical grounding system that is superior to conventional copper-rod and mesh-based grounding systems. Benefits imparted by the present invention include a manifold reduction in deployment cost, including reduced installation cost, lower material cost, reduced maintenance and inspection costs, and a reduction in loss and damage due to theft or normal wear. Further, the present invention offers a sub-ohm resistivity between earth (i.e., electrical ground) and any supported electronic system in all common operating conditions, given an appropriately scaled embodiment thereof.

To accomplish this, the system of the present invention utilizes an excavation tool 10, an installation site 11, a volume of substrate 14, a volume of catalyst 15, a volume of conductive additive 16, at least one ground lead 18, and at least one regulated current source 12 (Step A). The excavation tool 10 broadly refers to any implement, powered or hand-operated, which may be used to excavate and manipulate the terrain of the installation site 11. The preferred implements described herein, or any ancillary tooling as may be commonly employed in this field, are considered to fall within the original spirit and scope of the present invention.

The installation site 11 itself refers to a surveyed and prepared section of terrain, wherein an installer is presumed to have assessed the soil conditions for characteristics relevant to establishing an electric ground. More specifically, the installation site 11 refers to a zone of known electrical resistivity, permeability, soil composition, grain size, or other factors that may occur as relevant to any reasonably skilled individual.

The volume of substrate 14 ideally refers to a concrete or cement mixture that is or has been compatibilized with the installation site 11. However, the volume of substrate 14 may also define any type of suspension base, epoxy, or other curable compound as may be suitable for establishing a conductive ground within the installation site 11. The volume of substrate 14 further refers to any requisite activation agent in an appropriate ratio for immediate deployment within the installation site 11, e.g., premixed water in concrete or hardening agent in epoxy.

The volume of catalyst 15 constitutes any additive compound that will accelerate or otherwise modify the setting or curing process of the volume of substrate 14 when combined with the volume of substrate 14. In the preferred embodiment of the present invention, the volume of catalyst 15 defines a mixture of additive compounds that stratify the final density of the volume of substrate 14, thereby enabling a more effective dispersion of the finished volume of substrate 14 throughout the installation site 11.

The volume of conductive additive 16 ideally refers to a graphite particulate mass, though it is understood that the physical geometry and composition of the conductive additive may vary between embodiments of the present invention. Generally, the volume of conductive additive 16 refers to any conductive elements or compounds that are distributed into the volume of substrate 14 to increase the electrical conductivity therethrough.

The ground lead 18 refers to any cable, wire, conduit, or other conductive element that may interconnect the installation site 11 to at least one regulated current source 12. Accordingly, the current source refers to an electronic device or array of devices that are connected to a common return path to earth through the at least one ground lead 18.

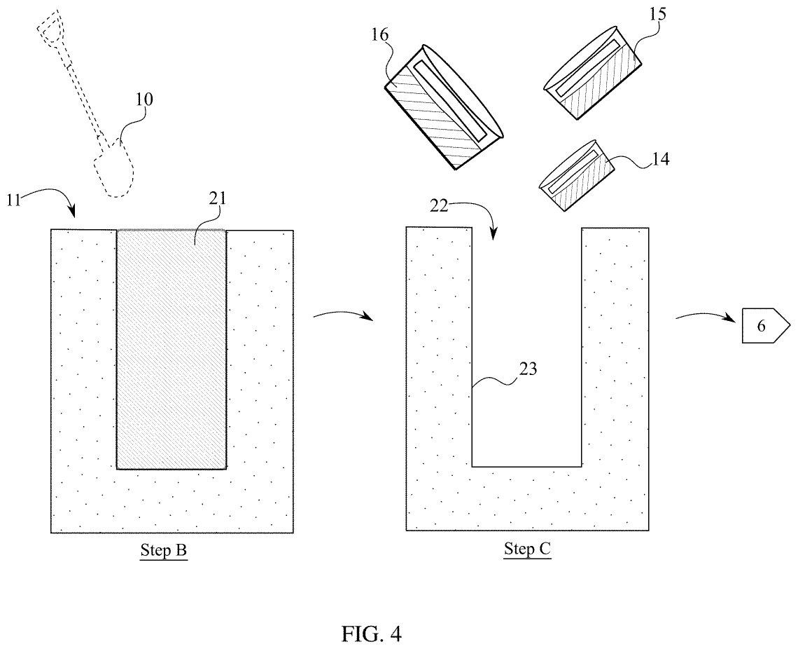

The overall process followed by the method of the present invention allows the aforementioned components of the system to be combined into an effective electrical ground system, wherein the order and effect of each sequential step is proposed to contribute to the formation of a uniquely effective ground connection. In reference to FIG. 4, the overall process begins by extracting a volume of filler material 21 from the installation site 11 with the excavation tool 10 to form an excavated cavity 22 (Step B). The volume of filler material 21 defines a combination of debris topsoil and subsoil displaced during the formation of the excavated cavity 22. The volume of filler material 21 is ideally localized to the installation site 11 and preserved for future use, thereby ensuring compositional homogeneity with any individual installation site 11. The excavated cavity 22 ideally conformed to a rectangular profile extending approximately 60 cm (2 ft.) below the surface of the installation site 11. Specific dimensions of the excavated cavity 22 are understood to be flexible, dependent on the requisite reduction in ground resistance for any given installation site 11. For example, a natural soil resistivity between under 50 ohms may be addressed with a single installation of approximately 50×20×20 cm (˜20×8×8 in.) with an achievable sub-ohm resistance. Soil resistivity in the kiloohm range may be addressed by larger implementations of a similar form, or by multiple instances of the graphite ground system linked to the at least one regulated current source 12.

The overall process continues by adding the volume of substrate 14, the volume of catalyst 15, and the volume of conductive additive 16 into the excavated cavity 22 to create a conductive slurry 17 (Step C). The conductive slurry 17 refers to any mixture, admixture, or combination of the volume of substrate 14, the volume of catalyst 15, and the volume of conductive additive 16 within the excavated cavity 22. In a preferred embodiment of the present invention the inclusion of each of the constituent materials may be staged or selectively delayed, thereby ensuring that the curing process of the volume of substrate 14 and the volume of catalyst 15 are controllable according to the needs of the installer. Delaying the inclusion of the complete volume of substrate 14 (e.g., cement mix and water) enables an installer to measure and pour all components into the excavated site before inserting the volume of substrate 14 to begin the setting process. Further, the use of a separate mixing vessel is eliminated as the excavated cavity 22 serves as an ad-hoc mixing barrel as the volume of conductive slurry 17 is created.

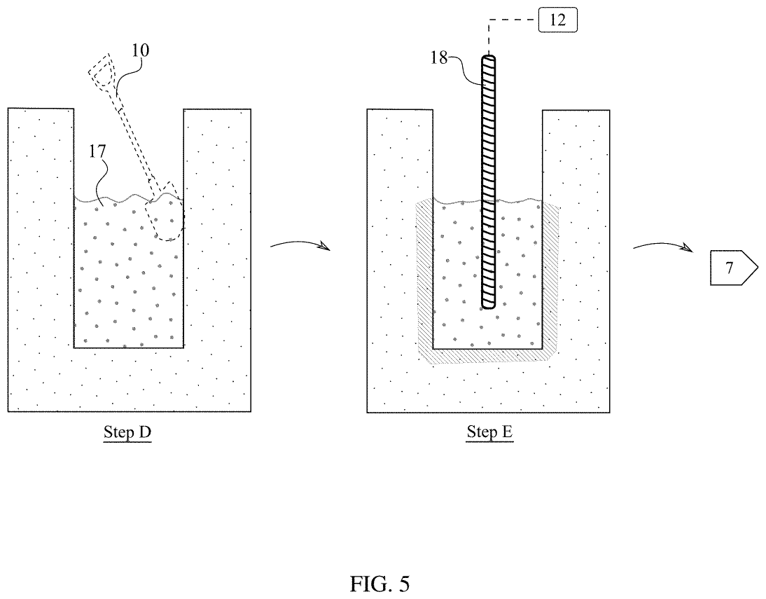

Accordingly, the overall process continues by agitating the conductive slurry 17 within the excavated cavity 22, wherein the conductive slurry 17 permeates the excavated cavity 22 (Step D). The conductive slurry 17 is ideally transformed into a suitably uniform mixture as the volume of conductive additive 16 is uniformly dispersed throughout the combined volume of substrate 14 and the volume of catalyst 15. This uniformity ensures that the conductive slurry 17 will provide a reliable electrical conductivity between the conductive slurry 17 and the installation site 11. Further, the uniform mixture of the conductive slurry 17 prevents material clumping that may impede permeation of the conductive slurry 17 into the excavated cavity 22. As the excavated cavity 22 is used as an ad-hoc mixing vessel, the agitation of the conductive slurry 17 is further proposed to accelerate the spread of the conductive slurry 17 throughout the excavated cavity 22 and into the soil of the installation site 11 as shown in FIG. 5. This process is proposed to provide superior contact to earth, as the increased surface area shared between the conductive slurry 17 and the excavated cavity 22 reduces the overall electrical resistance to ground across the conductive slurry 17.

The overall process of the present invention continues by inserting the at least one ground lead 18 into the conductive slurry 17, wherein the ground lead 18 is electrically connected between the at least one regulated current source 12 and the conductive slurry 17 (Step E). The insertion of the ground lead 18 is ideally performed while the conductive slurry 17 is uncured, or at least semi-solid, to enable the inserted portion of the ground lead 18 to be fully encased and captured by the conductive slurry 17 as the volume of substrate 14 and the volume of catalyst 15 cure into a solidified form. Though the ground lead 18 may be connected directly to the regulated current source 12 at this point, it is generally understood that the exposed end of the ground lead 18 may be displaced to anywhere outside of the excavated cavity 22 for later use. Provided that the ground lead 18 is exposed, the regulated current source 12 may be connected at any later time, or the ground lead 18 may be integrated into a larger network of grounding systems prior to integrating with the regulated current source 12 without departing from the original spirit and scope of the present invention.

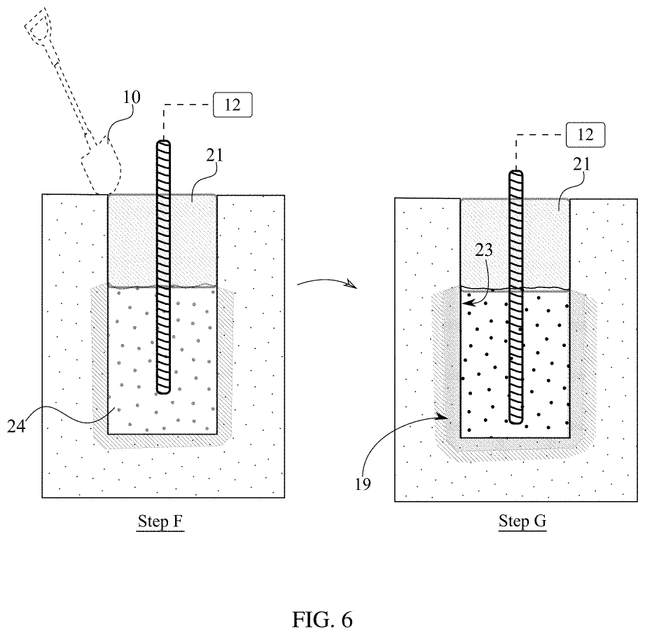

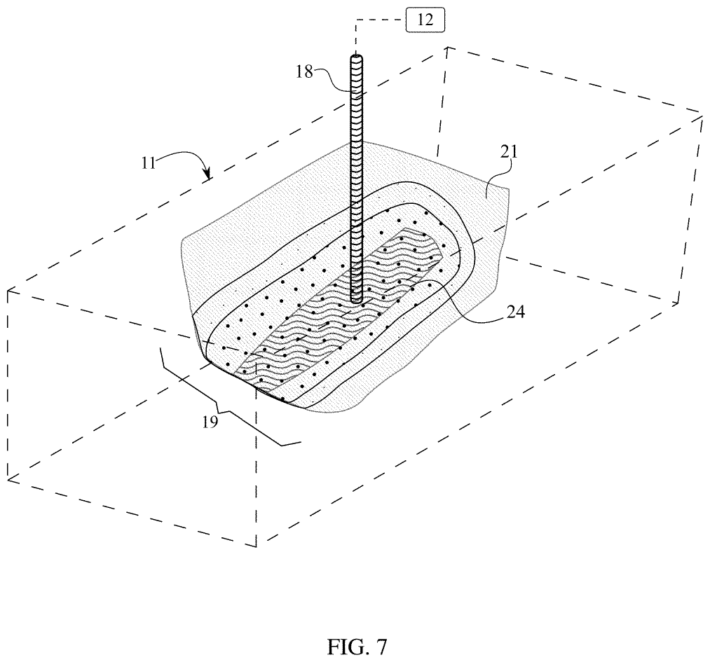

The overall method of the present invention continues by curing the conductive slurry 17 for a specified period of time in order to create a conductive ground element 24, wherein the conductive ground element 24 is a compacted and solidified form of the conductive slurry 17 (Step F). The period of time is understood to be variable between embodiments of the present invention, dependent on materials used, local atmospheric and ground conditions, and the overall volume of the conductive slurry 17. The compaction and solidification of the conductive slurry 17 post-permeation into the excavated cavity 22 is identified as critical to the long-term maintenance of an effective contact to earth, particularly during temperature shifts that may dislodge of the grounding systems. In the preferred embodiment of the present invention, the conductive ground element 24 refers to a solidified composition of the volume of substrate 14, the volume of catalyst 15, the volume of conductive additive 16, and the surrounding soil and debris present in the excavated cavity 22. As shown in FIG. 6, the conductive slurry 17 ideally permeates and compacts the soil of the installation site 11 adjacent to the excavated cavity 22, thereby creating a material gradient 19 between a pure conductive slurry 17 and the surrounding soil extending away from the central position of the ground lead 18 as shown in FIG. 7.

Finally, the overall method of the present invention concludes with replacing the volume of filler material 21 into the excavated cavity 22 atop the conductive ground element 24. The replacement of the volume of filler material 21 ensures that the conductive ground element 24 is fully engaged to the soil of the installation site 11, thereby minimizing the total measurable resistance to ground at the ground lead 18. Further, replacement of the volume of filler material 21 enables the conductive ground element 24 to be installed with minimal aesthetic disruption to the surface of the installation site 11, thereby concealing the presence of the conductive ground element 24 to thieves and vandals.

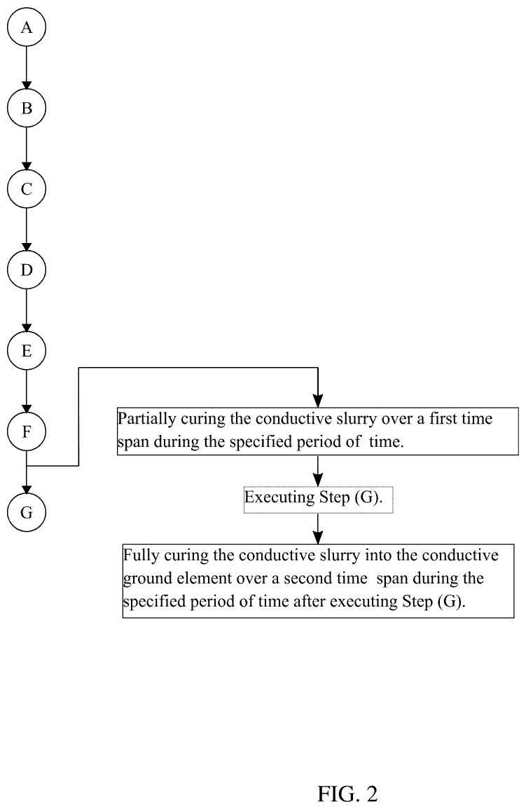

Referring to FIG. 2, a subprocess of the present invention begins with partially curing the conductive slurry 17 over a first time span during the specified period of time. While partially cured, the conductive slurry 17 ideally defines a semi-fluid mass with low viscosity relative to the conductive slurry 17 at the beginning of the specified period of time. The subprocess continues by replacing the volume of filler material 21 into the excavated cavity 22 atop the conductive ground element 24 (Step G), directly distributing the volume of filler material 21 into the partially cured conductive slurry 17. This arrangement enables the conductive slurry 17 to permeate and compact the volume of filler material 21 in a similar manner to the excavated cavity 22 and the surrounding soil of the installation site 11. The subprocess concludes by fully curing the conductive slurry 17 into the conductive ground element 24 over a second time span during the specified period of time after executing (Step G). The dispersal of the volume of filler material 21 into the partially cured conductive slurry 17 enables the formation of a material gradient 19 as described above, wherein the conductive slurry 17 remains most-pure closest to the center of the excavated cavity 22 but is gradually integrated with the surrounding soil at the extremities of the resultant conductive ground element 24. Consequently, the electrical resistance across the conductive slurry 17 to the common electrical return path is reduced as the surface contact with the surrounding soil is increased.

Another subprocess aims to increase the surface area of the excavated cavity 22 and disturb any loose soil therein prior to the introduction of the volume of conductive slurry 17. More specifically, the subprocess prepares the excavated cavity 22 to be permeated by the conductive slurry 17 by agitating at least one boundary 23 of the excavated cavity 22 with the excavation tool 10 during (Step B). The at least one boundary 23 is defined as any surface or sidewall of the installation site 11 that is adjacent to the excavated cavity 22 or is otherwise disposed to an area that may be filled by the conductive slurry 17. More specifically, he overall process maybe modified, wherein the volume of conductive slurry 17 permeates through the at least one boundary 23 during (Step D). Provided that the excavation tool 10 is already engaged in removing the volume of filler material 21 from the installation site 11 to form the excavated cavity 22, the excavation tool 10 is ideally situated to prepare the at least one boundary 23 for permeation by the conductive slurry 17. Further, the preparation of the at least one boundary 23 may be achieved in this manner without requiring any additional earthmoving equipment or interrupting any other operable steps.

The purposeful agitation and disruption of the at least one boundary 23 serves to create channels, indents, troughs, and gouges into which the conductive slurry 17 permeates, as outlined above. As the conductive slurry 17 cures and sets into the conductive ground element 24, the surrounding soil of the installation site 11 is effectively grafted into the conductive ground element 24 as the soil compacts around the excavated cavity 22. This on-site integration of the surrounding soil forms a material gradient 19 between the conductive slurry 17 and the at least one boundary 23, thereby ensuring that any electrical current carried into the conductive ground element 24 will encounter gradually increasing resistance crossing the at least one boundary 23 from the conductive slurry 17 into the surrounding soil of the installation site 11. The absence of any high-resistance connections to a common earth (material seams, gaps, drastically differing materials, etc.) minimizes or eliminates any thermal soaking that might otherwise occur in high-resistance sections of a ground circuit. In contrast, the material gradient 19 ensures that the conductive ground element 24 maintains an effective ground even as operating currents increase to the operating limits of the conductive slurry 17.

The graphite ground system is further expressed as a physical combination of disparate elements, wherein the combination of said disparate elements at specific ratios and relative positions offers greater utility than a generic description of the present invention. More specifically, the graphite ground system comprises the excavated cavity 22, the conductive slurry 17, and at least one conductive insert. The conductive slurry 17 is positioned within the excavated cavity 22, wherein the conductive slurry 17 permeates the excavated cavity 22 as described and arranged above. Likewise, the conductive insert is positioned into the conductive slurry 17 to complete a single embodiment of the physical components of the graphite ground system.

In at least one embodiment, the present invention further comprises at least one casting form. The casing form defines a mold or guiding structure configured to establish the initial shape of the conductive slurry 17 prior to being cured into the conductive ground element 24. In at least one instance, the casting form is at least partially permeable to enable the formation of a material gradient 19 as described previously. The casting form is positioned within the excavated cavity 22 and the conductive slurry 17 is positioned within the casting form. The conductive slurry 17 is constrained by the casting form, wherein the conductive slurry 17 will initially adopt the geometry of the casting form while still semi-liquid. The casting form may subsequently be removed or collapsed once a minimum cure quality is reached, e.g., if the conductive slurry 17 will substantially maintain the shape of the casting mold when unsupported. This arrangement enables the conductive slurry 17 to be shaped into desirable or consistent geometries without substantially altering the in-place casting of the conductive slurry 17, while also not compromising the solidification and compaction processes essential to the formation of an effective conductive ground element 24.

In a preferred embodiment, the conductive slurry 17 comprises the volume of conductor element, the volume of substrate 14, and a volume of catalyst 15. In relation to the previously described mixture processes, the relative ratios of the constituent components of the conductive slurry 17 are proposed to achieve an optimal set-time and working viscosity to permeate the excavated cavity 22 prior to solidifying. More specifically, the volume of conductive additive 16 is approximately 65 wt. % of the total mass of the conductive slurry 17, the volume of substrate 14 is approximately 15 wt. % of the total mass of the conductive slurry 17, and the volume of catalyst 15 is approximately 20 wt. % of the total mass of the conductive slurry 17. The overrepresentation of the volume of conductive additive 16 ensures that a significant percentage of the finished conductive ground element 24 will retain the conductive properties of the raw volume of conductive additive 16. The over-catalyzation of the volume of substrate 14 by the volume of catalyst 15 is likewise formulated to cure into a finished conductive ground element 24 with stratified density, i.e., as the conductive slurry 17 cures, the material gradient 19 will be maintained rather than settling-out any particulate soil or the volume of conductive additive 16.

It is further specified that the volume of conductive additive 16 is graphite particulate with a mean particle size (d50) between 300 μm to about 400 μm in the preferred embodiment of the present invention. This aggregate volume relative to supporting compounds, combined with a relatively large particulate diameter, ensures that the resultant conductive ground element 24 utilizing this material specification will retain excellent electrical conduction properties.

Further, it is proposed that the volume of substrate 14 is a hydrophilic cement. The use of a water-retaining compound in the volume of substrate 14 provides an increased conductivity to the surrounding soil, whereby the regulated current source 12 may discharge through the ground lead 18, across the conductive ground element 24, and into the surrounding earth across a wetted contact surface in most operating conditions.

In addition, the volume of catalyst 15 is proposed to comprise approximately equal parts calcium sulfate (CaSO4) and calcium carbonate (CaCO3). The calcium sulfate additive contributes to the finished strength of the conductive ground element 24 by preventing any flash-setting or shrinkage during the curing process. Both breakage or shrinkage would jeopardize the functionality of the present invention if any discontinuity were to form between the ground lead 18, the conductive ground element 24, and the surrounding soil during the curing process. Calcium carbonate is included to affect the workability of the uncured conductive slurry 17, thereby increasing the degree of permeating into the excavated cavity 22 and installation site 11 at large. Further, the individual grains of calcium carbonate ensure that micro-pits or voids do not form in the surface of the conductive ground element 24, thereby ensuring that the conductive ground element 24 remains in full contact with the surrounding soil once cured.

Although the invention has been explained in relation to its preferred embodiment, it is to be understood that many other possible modifications and variations can be made without departing from the spirit and scope of the invention as hereinafter claimed.

What is claimed is:

1. A method of preparing and installing a graphite ground system, the method comprises the steps of:
(A) providing an excavation tool, an installation site, a volume of substrate, a volume of catalyst, a volume of conductive additive, a ground lead, and at least one regulated current source;
(B) extracting a volume of filler material from the installation site with the excavation tool to form an excavated cavity;
(C) adding the volume of substrate, the volume of catalyst, and the volume of conductive additive into the excavated cavity to create a conductive slurry;
(D) agitating the conductive slurry within the excavated cavity, wherein the conductive slurry permeates the excavated cavity;
(E) inserting the at least one ground lead into the conductive slurry, wherein the ground lead is electrically connected between the at least one regulated current source and the conductive slurry;
(F) curing the conductive slurry for a specified period of time in order to create a conductive ground element, wherein the conductive ground element is a compacted and solidified form of the conductive slurry; and
(G) replacing the volume of filler material into the excavated cavity atop the conductive ground element.

2. The method of preparing and installing a graphite ground system as claimed in claim 1 comprising the steps of:
partially curing the conductive slurry over a first time span during the specified period of time;
executing Step (G); and
fully curing the conductive slurry into the conductive ground element over a second time span during the specified period of time after executing Step (G).

3. The method of preparing and installing a graphite ground system as claimed in claim 1 comprising the steps of:
agitating at least one boundary of the excavated cavity with the excavation tool during Step (B).

4. The method of preparing and installing a graphite ground system as claimed in claim 3, wherein the volume of conductive slurry permeates through the at least one boundary during Step (D).

5. T The method of preparing and installing a graphite ground system as claimed in claim 3, wherein a material gradient is formed between the conductive slurry and the at least one boundary.

6. A graphite ground system as claimed in claim 1 comprising:
an excavated cavity;
a conductive slurry;
at least one conductive insert;
the conductive slurry being positioned within the excavated cavity, wherein the conductive slurry permeates the excavated cavity; and
the conductive insert being positioned into the conductive slurry.

7. The graphite ground system as claimed in claim 6 comprising:
at least one casting form;
the casting form being positioned within the excavated cavity; and
the conductive slurry being positioned within the casting form, wherein the conductive slurry is constrained by the casting form.

8. The graphite ground system as claimed in claim 6 comprising:
the conductive slurry comprising a volume of conductive additive, a volume of substrate, and a volume of catalyst;
the volume of conductive additive being approximately 65 wt. % of the total mass of the conductive slurry;
the volume of substrate being approximately 15 wt. % of the total mass of the conductive slurry; and
the volume of catalyst being approximately 20 wt. % of the total mass of the conductive slurry.

9. The graphite ground system as claimed in claim 6 comprising:
the volume of conductive additive being graphite particulate with a mean particle size (d₅₀) between 300 μm to about 400 μm.

10. The graphite ground system as claimed in claim 6 comprising:
the volume of substrate being a hydrophilic cement.

11. The graphite ground system as claimed in claim 6 comprising:
the volume of catalyst being approximately equal parts calcium sulfate (CaSO₄) and calcium carbonate (CaCO₃).

12. The graphite ground system as claimed in claim 1 comprising:
an excavated cavity;
a conductive slurry;
at least one conductive insert;
the conductive slurry being positioned within the excavated cavity, wherein the conductive slurry permeates the excavated cavity;
the conductive insert being positioned into the conductive slurry,
at least one casting form;
the casting form being positioned within the excavated cavity;
the conductive slurry being positioned within the casting form, wherein the conductive slurry is constrained by the casting form;
the conductive slurry comprising a volume of conductive additive, a volume of substrate, and a volume of catalyst;
the quantity of conductive additive being approximately 65 wt. % of the total mass of the conductive slurry;
the volume of substrate being approximately 15 wt. % of the total mass of the conductive slurry;
the volume of catalyst being approximately 20 wt. % of the total mass of the conductive slurry;
the volume of conductive additive being graphite particulate with a mean particle size (d₅₀) between 300 μm to about 400 μm;
the volume of substrate being a hydrophilic cement; and
the volume of catalyst being equal parts calcium sulfate (CaSO₄) and calcium carbonate (CaCO₃).
